(19) United States
(12) Patent Application Publication
(10) Pub. No.: US 2009/0288422 A1
(43) Pub. Date: Nov. 26, 2009

(54) Component arrangement, combustion chamber arrangement and gas turbine

(76) Inventors: Christoph Cernay, (US); Stefan Tschirren, Laufen (CH)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/471,534

(22) Filed: May 26, 2009

(30) Foreign Application Priority Data
May 26, 2008 (EP) 08009563.1

(51) Int. Cl. F02C 7/20

(52) U.S. Cl. 60/800

(57) ABSTRACT

A component arrangement is provided which includes two component elements with portions pushed one into the other, leaving a gap and arranged statically with respect to one another. The component arrangement also includes a sealing element sealing off the gap. One of the component elements has a groove which runs in the region of the gap to be sealed off and is open towards the other component element. The component that has the groove has a side face. The sealing element includes a holding element with a first side face and with a second side face and is arranged at least partially in the groove. The first side face of the holding element can be pushed against the side face of the groove by a pressure difference. The side face of the groove and/or the first side face of the holding element include/includes at least one pressure relief depression.

### CROSS REFERENCE TO RELATED APPLICATIONS

This application claims priority of European Patent Office application No. 08009563.1 EP filed May 26, 2008, which is incorporated by reference herein in its entirety.

### FIELD OF INVENTION

The present invention relates to a component arrangement and a combustion chamber arrangement with a sealing element. The invention relates, moreover, to a gas turbine.

### BACKGROUND OF INVENTION

A combustion chamber, for example a combustion chamber of a gas turbine, often comprises various components which are partially pushed one into the other. In particular, the outlet of a flame tube and a transition element adjoining the flame tube are frequently pushed partially one into the other. The gap in this case typically occurring between the portions pushed one into the other has to be sealed off. This often takes place with the aid of clamping spring seals, but may also take place by means of brush seals.

In the case where a brush seal, which comprises a holding ring, or another sealing element comprising a holding ring is used, the pressure difference prevailing across the sealing element generates a lateral thrust on the holding ring which presses the ring onto the side face of a guide groove. This thrust is basically desirable and even necessary because the leakage flow around the guide ring is thereby reduced. If, in addition to this, the side face of the ring and the contact face of the guide groove have also been machined so as to be smooth and planar, this leakage is insignificant.

In a sealing arrangement of this type, it is important that the thrust force has to be rated and controlled correctly so that the sealing element functions, as intended. The thrust generates friction when the holding ring is displaced radially during operation, that is to say when a pressure difference prevails on it. These displacements must be possible on account of the intended purpose of the holding ring. If a brush seal is used, the frictional force has to be absorbed by the brush seal and by the two components sealed off with respect to one another.

If the ring height and/or the pressure difference are/is relatively high, this may lead to frictional forces which virtually block the holding ring in the guide groove. The structural elements involved may in this case be overloaded, and this may lead to damage, for example to a crushed brush, to deformations of the components or to cracks in the components. In order to prevent this, in particular, the size of the ring may be reduced as far as possible. Furthermore, to reduce the pressure difference, a plurality of sealing rings may be used in series. Moreover, the friction can be reduced in that the faces involved are smoothed and/or coated. However, these measures have proved to be insufficient in the case of larger ring diameters and/or higher pressure differences.

### SUMMARY OF INVENTION

An object of the present invention, therefore, is to make available an advantageous component arrangement which comprises two component elements with portions pushed one into the other, so as to leave a gap, and arranged statically with respect to one another, and a sealing element sealing off the gap. A further object of the present invention is to make available an advantageous combustion chamber arrangement. Moreover, an object of the present invention is to make available an advantageous gas turbine.

The first object is achieved by means of a component arrangement as claimed in the claims. The second object is achieved by means of a combustion chamber arrangement as claimed in the claims. The third object is achieved by means of a gas turbine as claimed in the claims. The dependent claims contain further advantageous refinements of the invention.

The component arrangement according to the invention comprises two component elements which comprise portions pushed one into the other, so as to leave a gap, and arranged statically with respect to one another.

The component arrangement comprises, moreover, a sealing element sealing off the gap. One of the two component elements has a groove which runs in the region of the gap to be sealed off and is open towards the other component element and which has a side face. The sealing element comprises a holding element with a first side face and with a second side face. The sealing element is arranged at least partially in the groove. The first side face of the holding element can be brought to bear on the side face of the groove by a pressure difference between a pressure acting on the first side face and a pressure acting on the second side face. The side face of the groove and/or the first side face of the holding element comprise/comprises at least one pressure relief depression.

Within the scope of the invention, “arranged statically with respect to one another” is to mean that the component portions do not rotate in relation to one another. Despite possible movements of the component portions according to the invention as a result of vibrations or thermal expansions, components which move in relation to one another in this way are considered, within the scope of the invention, as being arranged statically with respect to one another.

The term “groove” may be understood within the scope of the invention, in particular, in the sense of a guide groove.

By means of the pressure relief depression, the contact face of the component elements bearing one against the other is reduced. Consequently, the face on which the prevailing pressure difference acts is reduced. This gives rise, as a result of the lowered pressure force, to a reduction in the frictional force and prevents a blockage of the holding element and an overloading of the elements involved. In particular, by a suitable choice of the dimensions of the pressure relief depression, the force between those side faces of the groove and of the holding element which bear one against the other can be set. As a result, moreover, the frictional force acting between the side faces bearing one against the other can be influenced.

The groove may be configured, in particular, as an annular groove. Furthermore, the holding element may be configured as a holding ring. Moreover, the sealing element may be configured, for example, as a brush seal which may comprise, in particular, a holding ring with a brush. Alternatively, the sealing element may comprise a cord seal, an open annular seal (C-ring) or a closed annular seal (O-ring). In these cases, in particular, the holding ring may be connected to a cord seal, to an open annular seal (C-ring) or to a closed annular seal (O-ring). In a further alternative, the sealing element may be configured as a straightforward piston ring or holding ring.

Furthermore, the groove may run around the component element toward which it is open. In this case, the pressure relief depression may extend along the entire side face of the groove and/or along the entire first side face (31a) of the holding element. Alternatively to this, a plurality of pressure relief depressions in the form of segments may extend along the entire side face of the groove and/or along the entire first side face of the holding element. The pressure relief depression may therefore, in other words, be configured as a continuous channel or as a segmented channel. Segmentation gives rise, as compared with a pressure relief depression of unsegmented configuration, to an improved support of the holding ring and consequently to an increased stability of the component arrangement.

The side face of the groove and/or the first side face of the holding element may be coated. By the choice of a suitable coating material, the friction between the side faces bearing one against the other can likewise be reduced.

The pressure relief depression may have, in particular, a depth of between 1 mm and 10 mm, preferably of 1.5 mm.

One of those portions of the component elements which are pushed one into the other may, for example, form the outlet of a flame tube. In this case, it is advantageous if the outlet of a flame tube is arranged radially on the inside with respect to the portion of the other component element of those portions which are pushed one into the other. Thus, the hot gas emerging from the flame tube cannot flow through the gap in the direction of flow, but only opposite to the flow, thus assisting in reducing the leakage and allowing the use of smaller seals, as compared with a gap through which the hot gas can flow in the direction of flow. Moreover, within the framework of the proposed arrangement, the rear side of the inner component element is not wetted by the hot gas, and therefore the thermal load is reduced. Furthermore, the air quantity required for scavenging the gap is minimized.

Further, one of those portions of the component elements which are pushed one into the other may form a portion of a transition element (transition piece) which is arranged between a flame tube (combustor basket) and a turbine inlet. In this case, it is advantageous if the portion of the transition element is arranged radially on the outside with respect to the portion of the other structural element of those portions which are pushed one into the other. Here, too, only a throughflow of the gap opposite to the general direction of flow is then possible.

Those portions of the component elements which are pushed one into the other may, in particular, be of cylindrical configuration.

Advantageously, that component element which comprises the portion arranged radially on the outside with respect to the mid-axis of the portions pushed one into the other may have the groove. However, of course, that component element which comprises the portion arranged radially on the inside with respect to the mid-axis of the portions pushed one into the other may also have the groove.

The combustion chamber arrangement according to the invention comprises a flame tube with a flame tube outlet and a transition element which follows the flame tube outlet in the direction of flow of a hot gas emanating from the flame tube and which has an inlet adapted to the flame tube outlet. The flame tube outlet and the inlet of the transition element are partially pushed one into the other. In this case, a gap is formed between the flame tube outlet and the inlet of the transition element. The flame tube outlet or the transition element has an annular groove which runs in the region of the gap to be sealed off and which has a side face. The gap is sealed off by means of a sealing element which comprises a holding element with a first side face and with a second side face. The sealing element is arranged at least partially in the groove. The first side face of the holding element can be brought to bear on the side face of the groove by a pressure difference between a pressure acting on the first side face and a pressure acting on the second side face. The side face of the groove and/or the first side face of the holding element comprise/comprises at least one pressure relief depression.

By means of the pressure relief depression, the contact face of those side faces of the groove and of the holding element which bear one against the other is reduced. The face on which the prevailing pressure difference acts is consequently reduced. This brings about a reduction in the frictional force and prevents a blockage of the holding element and an overloading of the components involved. In particular, by a suitable choice of the dimensions of the pressure relief depression, the force between those side faces of the groove and of the holding element which bear one against the other can be set. As a result, moreover, the frictional force acting between the side faces bearing one against the other can be influenced.

The side face of the groove and/or the first side face of the holding element may be coated. By the choice of a suitable coating material, the friction between the side faces bearing one against the other can likewise be reduced.

The pressure relief depression may have, for example, a depth of between 1 mm and 10 mm, preferably of 1.5 mm.

Moreover, the groove may be configured as an annular groove. The sealing element may, for example, comprise a brush seal, a cord seal, an open annular seal (C-ring) or a closed annular seal (O-ring). In the case of the brush seal, this may comprise, in particular, a holding ring with a brush. However, the sealing element may also be configured as a straightforward piston ring or holding ring.

Further, the groove may run around the transition element or the flame tube outlet toward which it is open. In this case, the pressure relief depression may extend along the entire side face of the groove and/or along the entire first side face of the holding element. Alternatively to this, pressure relief depressions in the form of segments may extend along the entire side face of the groove and/or along the entire first side face of the holding element. Segmentation has the effect that the holding element or the holding ring is supported more effectively than in the case of an unsegmented continuous pressure relief depression.

Basically, both within the framework of the component arrangement according to the invention and within the framework of the combustion chamber arrangement according to the invention, a plurality of, for example two, pressure relief depressions may be arranged at various radial positions in the side face of the groove.

Furthermore, the edges of the side faces bearing one against the other may have a rounded or convex configuration. The contact face can thereby be reduced to a minimum.

The component arrangement according to the invention and the combustion chamber arrangement according to the invention can basically be used in any temperature range and with different media, for example air, water or oil, if the materials are chosen appropriately. The prevailing pressures, too, are, in principle, not limited. Should the pressure force be too low, in particular, the height of the ring may be increased in the radial direction.

The gas turbine according to the invention comprises a combustion chamber arrangement according to the invention, such as was described in the preceding paragraphs. The gas turbine according to the invention has the same advantages as the combustion chamber arrangement according to the invention.

### BRIEF DESCRIPTION OF THE DRAWINGS

Further features, properties and advantages of the present invention are described in more detail below by means of an exemplary embodiment with reference to the accompanying figures. The design variants are advantageous both individually and in combination with one another.

FIG. 1 shows diagrammatically a gas turbine.

FIG. 2 shows diagrammatically part of a combustion chamber arrangement of a gas turbine.

FIG. 3 shows diagrammatically a section through a component arrangement according to the invention.

FIG. 4 shows diagrammatically a section through an alternative component arrangement according to the invention.

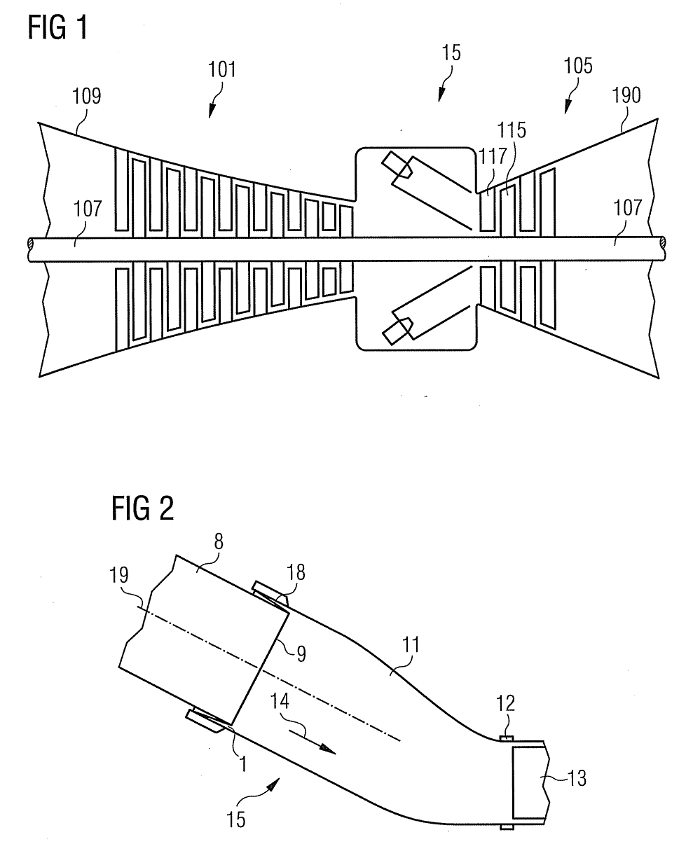

An exemplary embodiment of the present invention is described in more detail below with reference to FIGS. 1 to 4.

### DETAILED DESCRIPTION OF INVENTION

FIG. 1 shows diagrammatically a gas turbine. A gas turbine has inside it a rotor rotary-mounted about an axis of rotation and having a shaft 107, said rotor also being designated as a turbine rotor. An intake casing 109, a compressor 101, a plurality of combustion chamber arrangements 15, a turbine 105 and the exhaust gas casing 190 succeed one another along the rotor.

Each combustion chamber arrangement 15 communicates with an, for example, annular hot gas duct. There, a plurality of turbine stages connected in series form the turbine 105. Each turbine stage is formed from two blade rings. As seen in the direction of flow of a working medium, a guide blade row 117 is followed in the hot gas duct by a row formed from moving blades 115. The guide blades 117 are in this case fastened to an inner casing of a stator, whereas the moving blades 115 of a row are attached to the rotor, for example by means of a turbine disk. A generator or a working machine is coupled to the rotor.

When the gas turbine is in operation, air is sucked in through the intake casing 109 by the compressor 101 and is compressed. The compressed air provided at the turbine-end of the compressor 101 is routed to the combustion chamber arrangements 15 and is mixed there with a fuel. The mixture is then burnt in the combustion chamber so as to form the working medium. The working medium flows from there along the hot gas duct past the guide blades 117 and the moving blades 115. At the moving blades 115, the working medium expands so as to transmit a pulse, and therefore the moving blades 115 drive the rotor and the latter drives the working machine coupled to it.

FIG. 2 shows diagrammatically part of a combustion chamber arrangement 15 of a gas turbine. The combustion chamber arrangement 15 shown in FIG. 2 may, for example, be what is known as a can combustion chamber. The can combustion chambers are distributed equally along the circumference and are arranged concentrically with respect to the rotor 107. Each combustion chamber arrangement 15 comprises a flame tube 8 (combustor basket) and a transition element 11 (transition piece). In the flame tube 8, a mixture of fuel and air, generated by means of a burner, not illustrated, is burnt. The hot gas occurring in this case is conducted from the flame tube 8 via the transition element 11 to a turbine 105 where, as working medium, it drives the turbine blades 13 located in the turbine 105. The direction of flow of the hot gas in the combustion chamber arrangement 15 is identified by an arrow 14.

The mid-axis of the flame tube 8 and of those portions of the flame tube 8 and of the transition element 11 which are pushed one into the other is identified by reference numeral 19.

The flame tube 8 shown in FIG. 2 comprises, furthermore, an outlet 9, to which the transition element 11 is connected in such a way that a portion of the outlet 9 of the flame tube 8 is pushed into a portion of the transition element 11 adjoining it. The portions pushed one into the other in are in this case of cylindrical configuration. A gap 1 is formed between those portions of the flame tube 8 and of the transition element 11 which are pushed one into the other. This gap 1 has hitherto been sealed off, for example, by means of a clamping spring seal 18. Within the scope of the invention, however, it can preferably be sealed off with the aid of a brush seal or with the aid of another sealing element which is arranged at least partially in a guide groove.

The transition element 11 has a cross-sectional area which decreases in the direction of flow and which, moreover, changes from a circular area to a ring segment area. The end of the transition element 11 in the direction of flow 14 forms the turbine inlet 12.

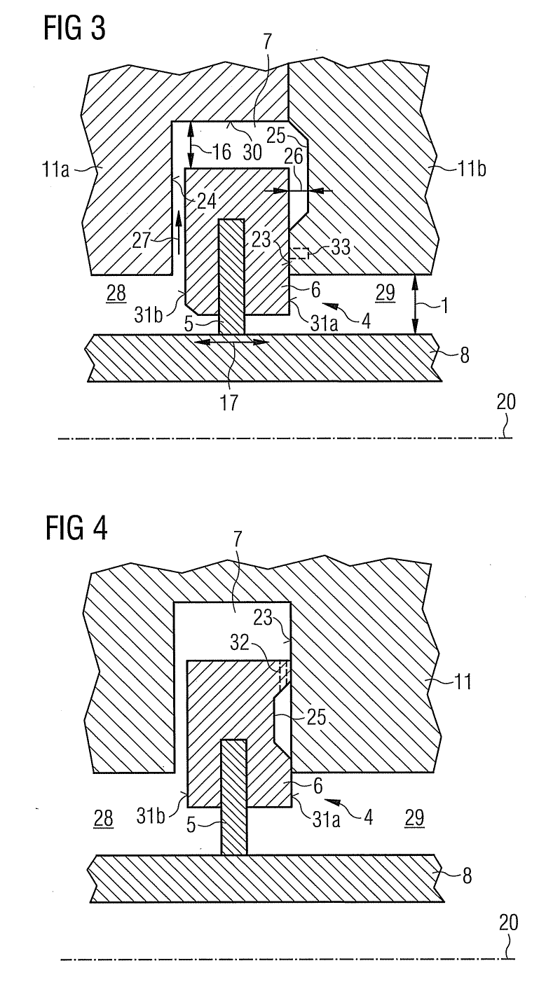

The component arrangement according to the invention, which may, in particular, be a combustion chamber arrangement according to the invention, is explained in more detail below with reference to FIGS. 3 and 4. FIGS. 3 and 4 show diagrammatically a section through two variants of a component arrangement according to the invention which, in the present exemplary embodiment, is a combustion chamber arrangement 21 in a gas turbine. Two component elements are illustrated, which are pushed one into the other. In the present exemplary embodiment, these are a portion of the flame tube 8 and a portion of the transition element 11. A gap 1 is located between those cylindrical portions of the flame tube 8 and of the transition element 11 which are pushed one into the other. This gap 1 is sealed off with the aid of a brush seal 4.

The brush seal 4 comprises a seal holder 6 and a brush 5. The brush 5 is in this case arranged in the seal holder 6 such that the bristles of the brush 5 are partially located inside the seal holder 6 and partially project out of the seal holder 6. The seal holder 6 is preferably configured as a piston ring. This ensures constant direct contact of the brush 5 with the surface of the flame tube 8.

The portion of the transition element 11 in FIGS. 3 and 4 has an annular groove 7 which runs in the region of the gap 1 to be sealed off and which has a radial direction with respect to the mid-axis 20. The seal holder 6 is inserted into this annular groove 7 in such a way that the seal holder 6 is displaceable radially with respect to a mid-axis 20. The direction of radial displaceability is identified by an arrow bearing reference numeral 16. The annular groove 7 and the brush holder 6 are arranged, furthermore, such that the seal holder 6 partially projects into the gap 1 and thereby partially seals off the gap 1. That part of the gap 1 which is not sealed off by the seal holder 6 is sealed off by the brush 5 projecting out of the seal holder 6 in the direction of the flame tube 8. The bristles of the brush 5 are in this case in direct contact with the surface of the flame tube 8.

The direction of a mutual axial displaceability of those two portions of the flame tube 8 and of the transition element 11 which are pushed one into the other, at the contact face between the surface of the flame tube 8 and the brush 5, is identified by an arrow bearing reference numeral 17. The radial displaceability of the seal holder 6 in the annular groove 7 allows a compensation of possible movements or displacements of the transition element 11 and of the flame tube 8 in the radial direction with respect to one another, for example as a result of thermal expansion or mechanical stresses.

During operation, the seal holder 6 must bear on a side face 23 of the annular groove 7, since a leakage may otherwise occur. The faces lying one against the other must be machined so as to be appropriately clean and planar. Typically, the seal holder 6 is pressed onto a side face 23 of the annular groove 7 as a result of the pressure difference across the seal. Basically, the seal holder 6 should have only little latitude of movement in the axial direction in the annular groove 7.

In contrast to the component arrangement shown in FIG. 4, the transition element shown in FIG. 3 has two components 11a and 11b connected to one another, for example screwed to one another. Of course, that part of the transition element 11 which is shown may also be manufactured from one component, as is shown in FIG. 4.

The component 11a in FIG. 3 comprises a first side face 24 and the bottom face 30 of the groove 7. The component 11b comprises a second side face 23 of the groove 7. The seal holder 6 comprises, in FIGS. 3 and 4, a first side face 31a and a second side face 31b. The first side face 31a of the seal holder 6 of the brush seal 4 can be brought to bear on the second side face 23 of the groove 7 by a pressure difference between a pressure acting on the first side face 31a and a pressure acting on the second side face 31b. In FIGS. 3 and 4, the first side face 31a of the seal holder 6 of the brush seal 4 bears on the second side face 23 of the groove 7.

When the gas turbine or the combustion chamber arrangement is in operation, a higher pressure prevails in the region identified by reference numeral 28 than in the region identified by reference numeral 29. On account of this pressure difference, the first side face 31a of the seal holder 6 is pressed onto the second side face 23 of the groove 7. Pressure compensation between the seal holder 6 and the first side face 24 takes place along the direction of flow identified by reference numeral 27.

The second side face 23 of the groove 7 has a pressure relief depression 25. The pressure relief depression 25 may, for example, have a depth 26 of between 1 mm and 10 mm, preferably of 1.5 mm. The pressure relief depression 25 may extend, in particular, along the entire side face 23 of the groove 7. Alternatively to this, the pressure relief depression 25 may have a segmented configuration in the circumferential direction. In this case, the segments may extend along the entire side face 23 of the groove 7. Segmentation has the effect that the seal holder 6 is supported more effectively than in the case of an unsegmented configuration.

Furthermore, optionally, an additional seal 33 may be arranged between the side faces 31a and 23 bearing one against the other. This is advantageous particularly when a leakage is to be feared between the side face 23 of the groove 7 and the side face 31a of the seal holder 6. The seal 33 may, for example, be an O-ring or a brush seal.

FIG. 4 shows diagrammatically a section through an alternative variant of a component arrangement according to the invention. In contrast to the variant shown in FIG. 3, the first side face 31a, bearing on the side face 23 of the groove 7, of the seal holder 6 has a pressure relief depression 25 which is flow-connected via a pressure compensation duct 32 to region 28 in which the higher pressure prevails. In this design variant, the side face 23 of the groove 7 does not comprise a pressure relief depression. In FIG. 4, the transition element 11 is configured as was described in connection with FIG. 3. It may have both a two-part or multipart configuration, as shown in FIG. 3, but also a one-part configuration, as shown in FIG. 4.

The pressure relief depression 25 shown in FIG. 4 has basically the same properties and advantages as the pressure relief depression 25 shown in FIG. 3. It may, in particular, extend along the entire first side face 31a of the holding element 6 and be of segmented configuration, as was described in connection with FIG. 3.

Moreover, within the framework of a design variant shown in FIG. 4, too, an additional seal 33, such as was described in connection with FIG. 3, may optionally be present between the side faces 31a and 23.

The pressure relief depression 25 gives rise, in both variants shown in FIGS. 3 and 4, to a reduction in the pressure-loaded area between the side face 23 of the groove 7 and the first side face 31a of the seal holder 6 and, consequently, to a reduction in the friction between these. Moreover, the reduction in the pressure-loaded area reduces the active thrust. By a suitable choice of the dimensions of the pressure relief depression 25, the force between those side faces 23, 31a of the groove 7 and of the seal holder 6 which bear one against the other can be set. As a result, moreover, the frictional force acting between the side faces bearing one against the other can be influenced.

Alternatively to the design variants described above, the combustion chamber arrangement according to the invention may also be configured such that that fraction of the flame tube 8 which is arranged so as to overlap with the transition element 11, that is to say the outlet 9 of the flame tube 8, comprises the groove 7. The statements made above also apply accordingly to this variant.

1.-19. (canceled)

20. A component arrangement, comprising:
a first component element;
a second component element comprising:
a groove, and
a first side face;
a gap; and
a sealing element comprising:
a holding element, having a second side face and a third side face,
wherein a first portion of the first component element is pushed into a second portion of the second component element leaving the gap between the first component element and the second component element,
wherein the first component element and the second component element are arranged so that the first component element and the second component element do not rotate with respect to each other,
wherein the sealing element seals off the gap and is partially arranged in the groove,
wherein the groove runs in a region of the gap and opens towards the first component,
wherein the second side face can be pushed against the first side face due to a pressure difference between a first pressure acting on the second side face and a second pressure acting on the third side face and,
wherein the first side face and/or the second side face comprise/comprises a pressure relief depression.

21. The component arrangement as claimed in claim 20, wherein the groove is configured as an annular groove.

22. The component arrangement as claimed in claim 21, wherein the holding element is configured as a holding ring.

23. The component arrangement as claimed in claim 20, wherein the sealing element further comprises a brush seal, a cord seal, an open annular seal or a closed annular seal.

24. The component arrangement as claimed in claim 20,
wherein the groove runs around a part of the second component element opening towards the first component element, and
wherein the pressure relief depression extends along the entire first side face and/or along the entire second side face.

25. The component arrangement as claimed in claim 20,
wherein the groove runs around a part of the second component element opening towards the first component element, and
wherein the pressure relief depression is segmented,
wherein a plurality of segments extend along the entire first side face and/or along the entire second side face.

26. The component arrangement as claimed in claim 20, wherein the first side face and/or the second side face are/is coated.

27. The component arrangement as claimed in claim 20, wherein the pressure relief depression has a depth in a range of 1 mm and 10 mm.

28. The component arrangement as claimed in claim 20,
wherein the first portion or the second portion form an outlet of the first component element.

29. The component arrangement as claimed in claim 20, wherein the first portion or the second portion form a portion of a transition element arranged between a flame tube and a turbine inlet.

30. The component arrangement as claimed in claim 20, wherein the first portion and the second portion are of a cylindrical configuration.

31. The component arrangement as claimed in claim 20,
wherein a second sealing element is arranged between the first side face and the second side face,
wherein the first side face and the second side face are pushed against each other, and
wherein the second sealing element is an O-ring or the brush seal.

32. A combustion chamber arrangement, comprising:
a flame tube having a flame tube outlet;
a transition element following the flame tube outlet in a direction of a flow of a hot gas emanating from the flame tube, the transition element comprising:
a groove, and
a first side face;
a gap; and
a sealing element comprising:
a holding element, having a second side face and a third side face,
wherein the transition element further comprises an inlet adapted to the flame tube outlet,
wherein the flame tube outlet is partially pushed into the inlet leaving a gap between the flame tube outlet and the inlet,
wherein the groove runs in a region of the gap and opens toward the flame tube outlet,
wherein the sealing element seals off the gap is partially arranged in the groove,
wherein and the second side face can be pushed against the first side face due to a pressure difference between a first pressure acting on the second side face and a second pressure acting on the third side face, and
wherein the first side face and/or the second side face comprise/comprises a pressure relief depression.

33. The combustion chamber arrangement as claimed in claim 32, wherein the first side face and/or the second side face are/is coated.

34. The combustion chamber arrangement as claimed in claim 32, wherein the pressure relief depression has a depth in a range between 1 mm and 10 mm.

35. The combustion chamber arrangement as claimed in claim 32 wherein the groove is configured as an annular groove.

36. The combustion chamber arrangement as claimed in claim 32, wherein the sealing element further comprises a brush seal, a cord seal, an open annular seal or a closed annular seal.

37. The combustion chamber arrangement as claimed in claim 32, wherein
wherein the groove runs around a part of the transition element opening towards the flame tube outlet, and
wherein the pressure relief depression extends along the entire first side face and/or along the entire second side face.

38. The combustion chamber arrangement as claimed in claim 37, wherein
wherein the groove runs around a part of the transition element opening towards the flame tube outlet, and
wherein the pressure relief depression is segmented,
wherein a plurality of segments extend along the entire first side face and/or along the entire second side face.

39. A gas turbine, comprising:
a combustion chamber arrangement, comprising:
a flame tube having a flame tube outlet,
a transition element following the flame tube outlet in a direction of a flow of a hot gas emanating from the flame tube, the transition element comprising:
a groove, and
a first side face,
a gap, and
a sealing element comprising,
a holding element, having a second side face and a third side face,
wherein the transition element further comprises an inlet adapted to the flame tube outlet,
wherein the flame tube outlet is partially pushed into the inlet leaving a gap between the flame tube outlet and the inlet,
wherein the groove runs in a region of the gap and opens toward the flame tube outlet,
wherein the sealing element seals off the gap is partially arranged in the groove,
wherein and the second side face can be pushed against the first side face due to a pressure difference between a first pressure acting on the second side face and a second pressure acting on the third side face, and
wherein the first side face and/or the second side face comprise/comprises a pressure relief depression.
